(19) United States
(12) Patent Application Publication
(10) Pub. No.: US 2024/0214363 A1
(43) Pub. Date: Jun. 27, 2024

(54) Cloud-based tunnel protocol systems and methods for multiple ports and protocols

(71) Applicant: Zscaler, Inc., San Jose, CA (US)

(72) Inventors: Srikanth Devarajan, San Jose, CA (US); Vijay Bulusu, Fremont, CA (US); Roy Rajan, Bangalore (IN); Ajit Singh, Fremont, CA (US); Abhinav Bansal, San Jose, CA (US); Vikas Mahajan, Ludhiana (IN)

(73) Assignee: Zscaler, Inc., San Jose, CA (US)

(21) Appl. No.: 18/594,541

(22) Filed: Mar. 4, 2024

Related U.S. Application Data
(63) Continuation-in-part of application No. 16/922,242, filed on Jul. 7, 2020, now Pat. No. 11,949,663.

(30) Foreign Application Priority Data
May 21, 2020 (IN) 202011021371

(51) Int. Cl. H04L 9/40

(52) U.S. Cl. CPC H04L 63/0435; H04L 63/029; H04L 63/1466

(57) ABSTRACT

Systems and methods include responsive to receiving a request at a remote node, determining whether the request is to be sent directly or via a cloud-based system; establishing a control channel of a tunnel utilizing a first encryption technique, wherein the tunnel is between the remote node and a local node, and wherein the control channel includes a session identifier; establishing a data channel of the tunnel utilizing a second encryption technique, wherein the data tunnel is bound to the control channel based on the session identifier; performing, over the control channel, device authentication and user authentication of one or more users associated with the remote node, wherein each of the one or more users includes a user identifier; and, subsequent to the device authentication and the user authentication, exchanging data packets over the data channel with each data packet including a corresponding user identifier.

### CROSS-REFERENCE TO RELATED APPLICATION(S)

The present disclosure is a continuation-in-part of U.S. patent application Ser. No. 16/922,242, filed Jul. 7, 2020, and entitled “Cloud-based tunnel protocol systems and methods for multiple ports and protocols,” the contents of which are incorporated by reference in their entirety.

### FIELD OF THE DISCLOSURE

The present disclosure generally relates to computer networking systems and methods. More particularly, the present disclosure relates to cloud-based tunnel protocol systems and methods for multiple ports and protocols.

### BACKGROUND OF THE DISCLOSURE

There is a staggering growth of user devices in enterprises coupled with a shift in remote work. With this influx, Information Technology (IT) administrators can no longer ignore these user devices, remote users, etc. as simply outside their scope of responsibility. Correspondingly, there has been an unprecedented growth in the cloud services that are made available by an enterprise to its employees, contractors, partners, etc. Traditionally, enterprises have deployed one secure application for each service for each platform, but this has eventually failed to scale with the growth of mobility in IT. There are myriad numbers of cloud-based services that are being accessed from user devices across diverse operating systems, uncontrolled network topologies, and vaguely understood mobile geographies. Typically, enterprises have deployed applications for a specific service, applications to access corporate resources that themselves vary for different network conditions, and applications to secure the endpoints itself.

With the move to remote work, there is a need to efficiently support security functions for remote users (Work From Home (WFH), road warriors, branch offices, etc.) in a manner that avoids backhauling all of the traffic to a corporate data center. The objective is to provide such remote users with the security functions via the cloud, and in doing so, there is a requirement to tunnel such traffic to a cloud-based system efficiently.

### BRIEF SUMMARY OF THE DISCLOSURE

The present disclosure relates to cloud-based tunnel protocol systems and methods for multiple ports and protocols. Specifically, the present disclosure includes a tunnel that can use either Datagram Transport Layer Security (DTLS) or Transport Layer Security (TLS) to forward packets between user devices and a cloud service, including packets on various ports and having different protocols. The objective with the tunnel is to support a suite of security functions via cloud services for remote users, including firewall and Intrusion Prevention System (IPS) features. The tunnel supports user-based granular policies (for web, Secure Sockets Layer (SSL), firewall, etc.) as well as visibility of user traffic. The tunnel uses DTLS or TLS for encryption to defend the remote users between their network access and cloud service access. Further, the tunnel can map and identify mobile application traffic for logging and for applying app-based granular policies.

Systems and methods include responsive to receiving a request at a remote node, determining whether the request is to be sent directly or via a cloud-based system; responsive to determining the request is to be sent via the cloud-based system, establishing a control channel of a tunnel utilizing a first encryption technique, wherein the tunnel is between the remote node and a local node, and wherein the control channel includes a session identifier; and establishing a data channel of the tunnel utilizing a second encryption technique, wherein the data channel is bound to the control channel based on the session identifier.

The steps can further include wherein the determining is based on any of a domain and a hostname of a destination associated with the request. The steps can further include responsive to determining the request is to be sent directly, forwarding the request direct to the Internet. The first encryption technique can be one of Transport Layer Security (TLS) and Secure Sockets Layer (SSL), and the second encryption technique can be one of TLS and Datagram Transport Layer Security (DTLS). The first encryption technique can be a same one of TLS and SSL, and the second encryption technique can be selected as the one of TLS and DTLS based on support of the remote node. The steps can further include performing, over the control channel, device authentication and user authentication of one or more users associated with the remote node, wherein each of the one or more users includes a user identifier; and subsequent to the device authentication and the user authentication, exchanging data packets over the data channel with each data packet including a corresponding user identifier. The data packets can include data packets between the remote node and the local node from various ports and having different protocols. The data packets can be exchanged over the control channel. The first encryption technique and the second encryption technique can be different. The local node can be part of a cloud-based security system and the one or more users can be connected thereto via the tunnel for firewall and Intrusion Prevention System (IPS) functions.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a cloud-based system offering security as a service;

FIG. 2 is a network diagram of an example implementation of the cloud-based system;

FIG. 3 is a block diagram of a server that may be used in the cloud-based system of FIGS. 1 and 2 or the like;

FIG. 4 is a block diagram of a user device that may be used with the cloud-based system of FIGS. 1 and 2 or the like;

FIG. 5 is a network diagram of the cloud-based system illustrating an application on user devices with users configured to operate through the cloud-based system;

FIG. 6 is a network diagram of a Zero Trust Network Access (ZTNA) application utilizing the cloud-based system of FIGS. 1 and 2;

FIG. 7 is a network diagram of the cloud-based system of FIGS. 1 and 2 in an application of digital experience monitoring;

FIG. 8 is a network diagram of the cloud-based system of FIGS. 1 and 2 with various cloud tunnels, labeled as cloud tunnels, for forwarding traffic;

FIGS. 9 and 10 are flow diagrams of a cloud tunnel illustrating a control channel (FIG. 9) and a data channel (FIG. 10), with the tunnel illustrated between a client and a server;

FIG. 11 is a flow diagram of details of a handshake process between the client and the server;

FIG. 12 is a flow diagram of a process for performing domain bypassing within cloud tunnels; and

FIG. 13 is a process for establishing a cloud tunnel for forwarding traffic between a remote node and a local node.

### DETAILED DESCRIPTION OF THE DISCLOSURE

Again, the present disclosure relates to cloud-based tunnel protocol systems and methods for multiple ports and protocols. Specifically, the present disclosure includes a tunnel that can use either Datagram Transport Layer Security (DTLS) or Transport Layer Security (TLS) to forward packets between user devices and a cloud service, including packets on various ports and having different protocols. The objective with the tunnel is to support a suite of security functions via cloud services for remote users, including firewall and Intrusion Prevention System (IPS) features. The tunnel supports user-based granular policies (for web, Secure Sockets Layer (SSL), firewall, etc.) as well as visibility of user traffic. The tunnel uses DTLS or TLS for encryption to defend the remote users between their network access and cloud service access. Further, the tunnel can map and identify mobile application traffic for logging and for applying app-based granular policies.

### Example Cloud-Based System Architecture

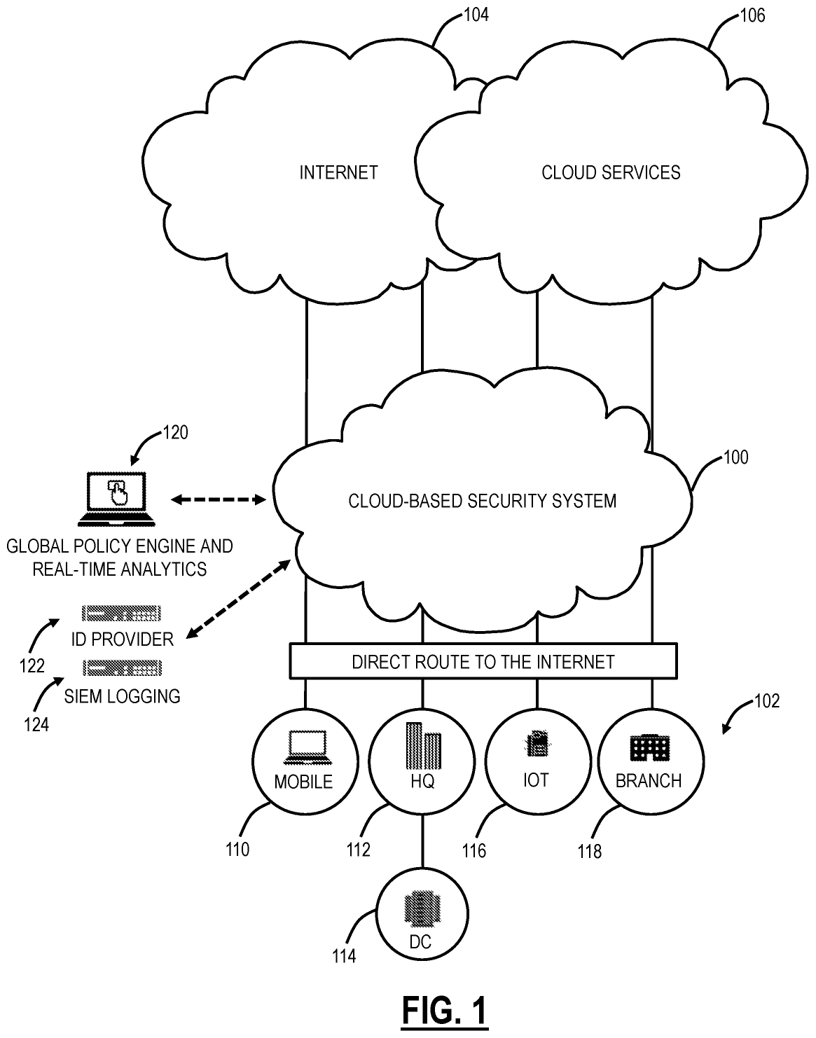

FIG. 1 is a network diagram of a cloud-based system 100 offering security as a service. Specifically, the cloud-based system 100 can offer a Secure Internet and Web Gateway as a service to various users 102, as well as other cloud services. In this manner, the cloud-based system 100 is located between the users 102 and the Internet as well as any cloud services 106 (or applications) accessed by the users 102. As such, the cloud-based system 100 provides inline monitoring inspecting traffic between the users 102, the Internet 104, and the cloud services 106, including Secure Sockets Layer (SSL) traffic. The cloud-based system 100 can offer access control, threat prevention, data protection, etc. The access control can include a cloud-based firewall, cloud-based intrusion detection, Uniform Resource Locator (URL) filtering, bandwidth control, Domain Name System (DNS) filtering, etc. The threat prevention can include cloud-based intrusion prevention, protection against advanced threats (malware, spam, Cross-Site Scripting (XSS), phishing, etc.), cloud-based sandbox, antivirus, DNS security, etc. The data protection can include Data Loss Prevention (DLP), cloud application security such as via Cloud Access Security Broker (CASB), file type control, etc.

The cloud-based firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The cloud-based intrusion prevention and advanced threat protection can deliver full threat protection against malicious content such as browser exploits, scripts, identified botnets and malware callbacks, etc. The cloud-based sandbox can block zero-day exploits (just identified) by analyzing unknown files for malicious behavior. Advantageously, the cloud-based system 100 is multi-tenant and can service a large volume of the users 102. As such, newly discovered threats can be promulgated throughout the cloud-based system 100 for all tenants practically instantaneously. The antivirus protection can include antivirus, antispyware, antimalware, etc. protection for the users 102, using signatures sourced and constantly updated. The DNS security can identify and route command-and-control connections to threat detection engines for full content inspection.

The DLP can use standard and/or custom dictionaries to continuously monitor the users 102, including compressed and/or SSL-encrypted traffic. Again, being in a cloud implementation, the cloud-based system 100 can scale this monitoring with near-zero latency on the users 102. The cloud application security can include CASB functionality to discover and control user access to known and unknown cloud services 106. The file type controls enable true file type control by the user, location, destination, etc. to determine which files are allowed or not.

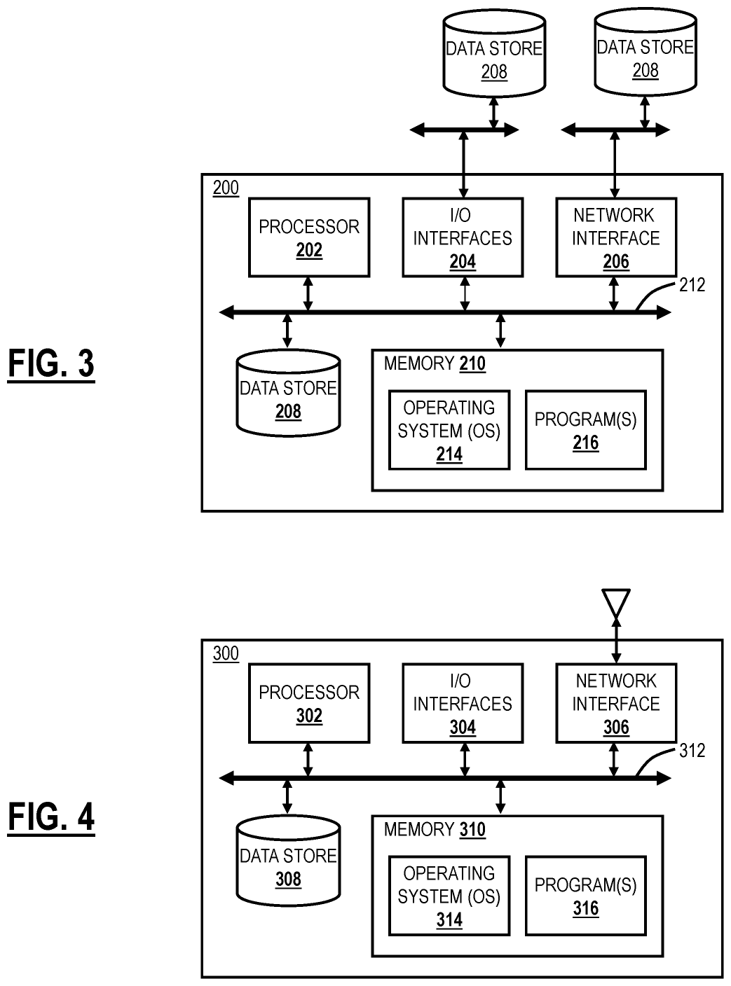

For illustration purposes, the users 102 of the cloud-based system 100 can include a mobile device 110, a headquarters (HQ) 112 which can include or connect to a data center (DC) 114, Internet of Things (IoT) devices 116, a branch office/remote location 118, etc., and each includes one or more user devices (an example user device 300 is illustrated in FIG. 3). The devices 110, 116, and the locations 112, 114, 118 are shown for illustrative purposes, and those skilled in the art will recognize there are various access scenarios and other users 102 for the cloud-based system 100, all of which are contemplated herein. The users 102 can be associated with a tenant, which may include an enterprise, a corporation, an organization, etc. That is, a tenant is a group of users who share a common access with specific privileges to the cloud-based system 100, a cloud service, etc. In an embodiment, the headquarters 112 can include an enterprise's network with resources in the data center 114. The mobile device 110 can be a so-called road warrior, i.e., users that are off-site, on-the-road, etc. Further, the cloud-based system 100 can be multi-tenant, with each tenant having its own users 102 and configuration, policy, rules, etc. One advantage of the multi-tenancy and a large volume of users is the zero-day/zero-hour protection in that a new vulnerability can be detected and then instantly remediated across the entire cloud-based system 100. The same applies to policy, rule, configuration, etc. changes—they are instantly remediated across the entire cloud-based system 100. As well, new features in the cloud-based system 100 can also be rolled up simultaneously across the user base, as opposed to selective and time-consuming upgrades on every device at the locations 112, 114, 118, and the devices 110, 116.

Logically, the cloud-based system 100 can be viewed as an overlay network between users (at the locations 112, 114, 118, and the devices 110, 106) and the Internet 104 and the cloud services 106. Previously, the IT deployment model included enterprise resources and applications stored within the data center 114 (i.e., physical devices) behind a firewall (perimeter), accessible by employees, partners, contractors, etc. on-site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators. As an ever-present overlay network, the cloud-based system 100 can provide the same functions as the physical devices and/or appliances regardless of geography or location of the users 102, as well as independent of platform, operating system, network access technique, network access provider, etc.

There are various techniques to forward traffic between the users 102 at the locations 112, 114, 118, and via the devices 110, 116, and the cloud-based system 100. Typically, the locations 112, 114, 118 can use tunneling where all traffic is forward through the cloud-based system 100. For example, various tunneling protocols are contemplated, such as Generic Routing Encapsulation (GRE), Layer Two Tunneling Protocol (L2TP), Internet Protocol (IP) Security (IPsec), customized tunneling protocols, etc. The devices 110, 116 can use a local application that forwards traffic, a proxy such as via a Proxy Auto-Config (PAC) file, and the like. A key aspect of the cloud-based system 100 is all traffic between the users 102 and the Internet 104 or the cloud services 106 is via the cloud-based system 100. As such, the cloud-based system 100 has visibility to enable various functions, all of which are performed off the user device in the cloud.

The cloud-based system 100 can also include a management system 120 for tenant access to provide global policy and configuration as well as real-time analytics. This enables IT administrators to have a unified view of user activity, threat intelligence, application usage, etc. For example, IT administrators can drill-down to a per-user level to understand events and correlate threats, to identify compromised devices, to have application visibility, and the like. The cloud-based system 100 can further include connectivity to an Identity Provider (IDP) 122 for authentication of the users 102 and to a Security Information and Event Management (SIEM) system 124 for event logging. The system 124 can provide alert and activity logs on a per-user 102 basis.

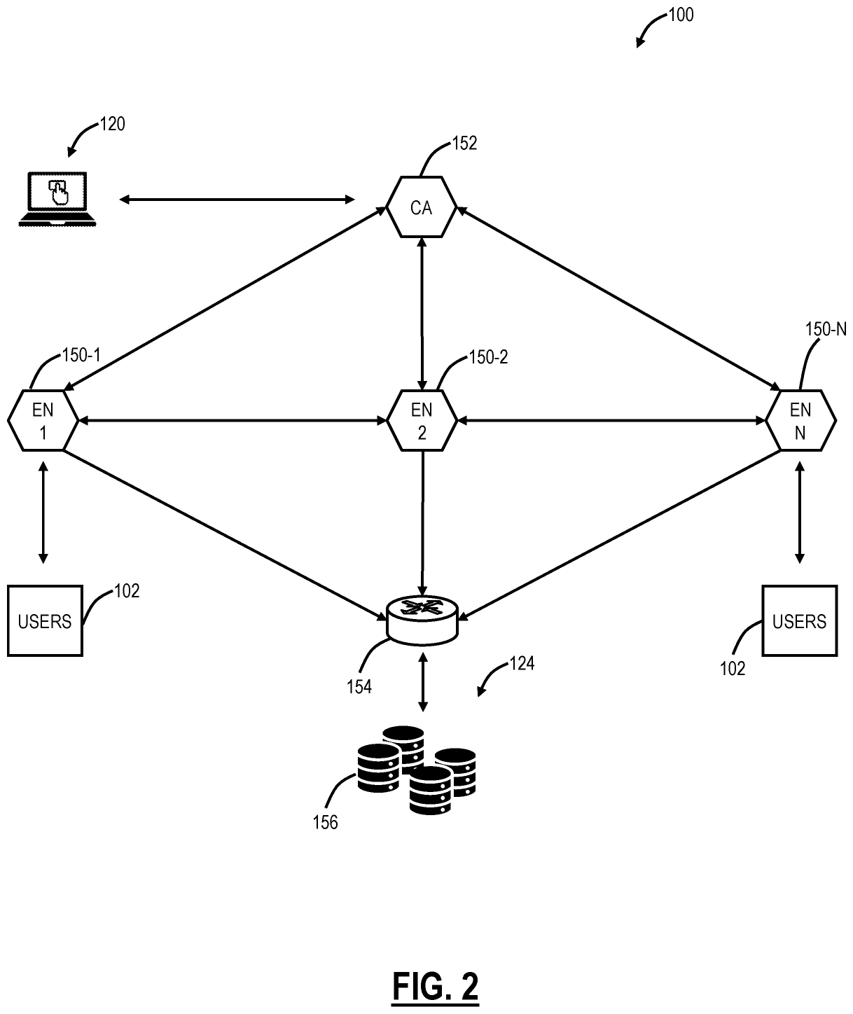

FIG. 2 is a network diagram of an example implementation of the cloud-based system 100. In an embodiment, the cloud-based system 100 includes a plurality of enforcement nodes (EN) 150, labeled as enforcement nodes 150-1, 150-2, 150-N, interconnected to one another and interconnected to a central authority (CA) 152. The nodes 150, 152, while described as nodes, can include one or more servers, including physical servers, virtual machines (VM) executed on physical hardware, etc. That is, a single node 150, 152 can be a cluster of devices. An example of a server is illustrated in FIG. 2. The cloud-based system 100 further includes a log router 154 that connects to a storage cluster 156 for supporting log maintenance from the enforcement nodes 150. The central authority 152 provide centralized policy, real-time threat updates, etc. and coordinates the distribution of this data between the enforcement nodes 150. The enforcement nodes 150 provide an onramp to the users 102 and are configured to execute policy, based on the central authority 152, for each user 102. The enforcement nodes 150 can be geographically distributed, and the policy for each user 102 follows that user 102 as he or she connects to the nearest (or other criteria) enforcement node 150.

The enforcement nodes 150 are full-featured secure internet gateways that provide integrated internet security. They inspect all web traffic bi-directionally for malware and enforce security, compliance, and firewall policies, as described herein. In an embodiment, each enforcement node 150 has two main modules for inspecting traffic and applying policies: a web module and a firewall module. The enforcement nodes 150 are deployed around the world and can handle hundreds of thousands of concurrent users with millions of concurrent sessions. Because of this, regardless of where the users 102 are, they can access the Internet 104 from any device, and the enforcement nodes 150 protect the traffic and apply corporate policies. The enforcement nodes 150 can implement various inspection engines therein, and optionally, send sandboxing to another system. The enforcement nodes 150 include significant fault tolerance capabilities, such as deployment in active-active mode to ensure availability and redundancy as well as continuous monitoring.

In an embodiment, customer traffic is not passed to any other component within the cloud-based system 100, and the enforcement nodes 150 can be configured never to store any data to disk. Packet data is held in memory for inspection and then, based on policy, is either forwarded or dropped. Log data generated for every transaction is compressed, tokenized, and exported over secure TLS connections to the log routers 154 that direct the logs to the storage cluster 156, hosted in the appropriate geographical region, for each organization.

The central authority 152 hosts all customer (tenant) policy and configuration settings. It monitors the cloud and provides a central location for software and database updates and threat intelligence. Given the multi-tenant architecture, the central authority 152 is redundant and backed up in multiple different data centers. The enforcement nodes 150 establish persistent connections to the central authority 152 to download all policy configurations. When a new user connects to an enforcement node 150, a policy request is sent to the central authority 152 through this connection. The central authority 152 then calculates the policies that apply to that user 102 and sends the policy to the enforcement node 150 as a highly compressed bitmap.

Once downloaded, a tenant's policy is cached until a policy change is made in the management system 120. When this happens, all of the cached policies are purged, and the enforcement nodes 150 request the new policy when the user 102 next makes a request. In an embodiment, the enforcement node 150 exchange “heartbeats” periodically, so all enforcement nodes 150 are informed when there is a policy change. Any enforcement node 150 can then pull the change in policy when it sees a new request.

The cloud-based system 100 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based system 100 is illustrated herein as an example embodiment of a cloud-based system, and other implementations are also contemplated.

As described herein, the terms cloud services and cloud applications may be used interchangeably. The cloud service 106 is any service made available to users on-demand via the Internet, as opposed to being provided from a company's on-premises servers. A cloud application, or cloud app, is a software program where cloud-based and local components work together. The cloud-based system 100 can be utilized to provide example cloud services, including Zscaler Internet Access (ZIA), Zscaler Private Access (ZPA), and Zscaler Digital Experience (ZDX), all from Zscaler, Inc. (the assignee and applicant of the present application). The ZIA service can provide the access control, threat prevention, and data protection described above with reference to the cloud-based system 100. ZPA can include access control, microservice segmentation, etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services 106 are also contemplated. Also, other types of cloud architectures are also contemplated, with the cloud-based system 100 presented for illustration purposes.

### Example Server Architecture

FIG. 3 is a block diagram of a server 200, which may be used in the cloud-based system 100, in other systems, or standalone. For example, the enforcement nodes 150 and the central authority 152 may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 3 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### Example User Device Architecture

FIG. 4 is a block diagram of a user device 300, which may be used with the cloud-based system 100 or the like. Specifically, the user device 300 can form a device used by one of the users 102, and this may include common devices such as laptops, smartphones, tablets, netbooks, personal digital assistants, MP3 players, cell phones, e-book readers, IoT devices, servers, desktops, printers, televisions, streaming media devices, and the like. The user device 300 can be a digital device that, in terms of hardware architecture, generally includes a processor 302, I/O interfaces 304, a network interface 306, a data store 308, and memory 310. It should be appreciated by those of ordinary skill in the art that FIG. 4 depicts the user device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network such as the cloud-based system 100.

### User Device Application for Traffic Forwarding and Monitoring

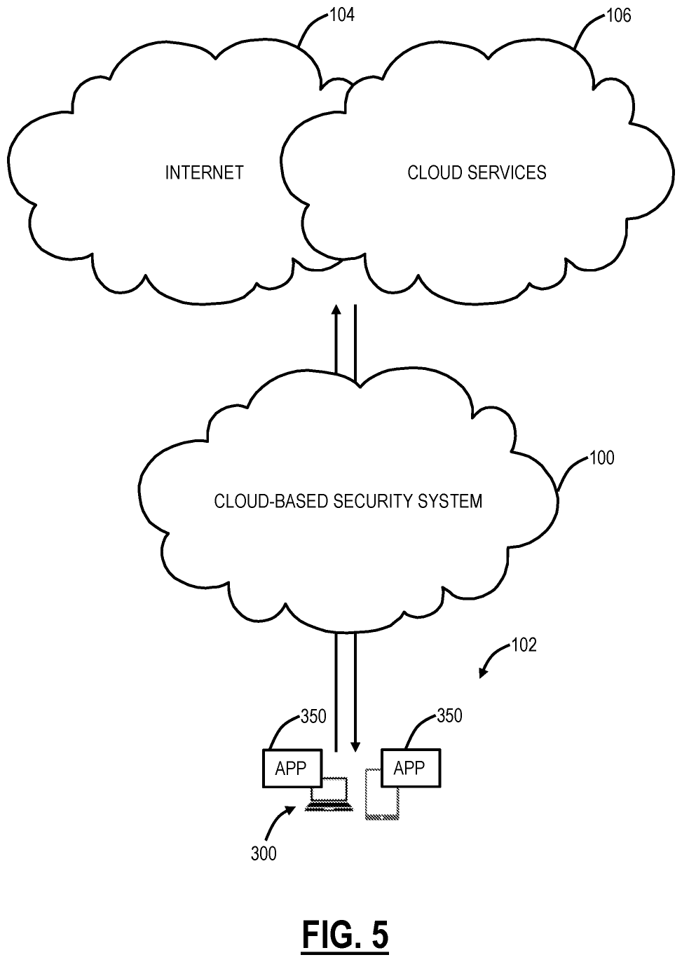

FIG. 5 is a network diagram of the cloud-based system 100 illustrating an application 350 on user devices 300 with users 102 configured to operate through the cloud-based system 100. Different types of user devices 300 are proliferating, including Bring Your Own Device (BYOD) as well as IT-managed devices. The conventional approach for a user device 300 to operate with the cloud-based system 100 as well as for accessing enterprise resources includes complex policies, VPNs, poor user experience, etc. The application 350 can automatically forward user traffic with the cloud-based system 100 as well as ensuring that security and access policies are enforced, regardless of device, location, operating system, or application. The application 350 automatically determines if a user 102 is looking to access the open Internet 104, a SaaS app, or an internal app running in public, private, or the datacenter and routes mobile traffic through the cloud-based system 100. The application 350 can support various cloud services, including ZIA, ZPA, ZDX, etc., allowing the best in class security with zero trust access to internal apps.

The application 350 is configured to auto-route traffic for a seamless user experience. This can be protocol as well as application-specific, and the application 350 can route traffic with a nearest or best fit enforcement node 150. Further, the application 350 can detect trusted networks, allowed applications, etc. and support secure network access. The application 350 can also support the enrollment of the user device 300 before accessing applications. The application 350 can uniquely detect the users 102 based on fingerprinting the user device 300, using criteria like device model, platform, operating system, etc. The application 350 can support Mobile Device Management (MDM) functions, allowing IT personnel to deploy and manage the user devices 300 seamlessly. This can also include the automatic installation of client and SSL certificates during enrollment. Finally, the application 350 provides visibility into device and app usage of the user 102 of the user device 300.

The application 350 supports a secure, lightweight tunnel between the user device 300 and the cloud-based system 100. For example, the lightweight tunnel can be HTTP-based. With the application 350, there is no requirement for PAC files, an IPSec VPN, authentication cookies, or end user 102 setup.

### Zero Trust Network Access Using the Cloud-Based System

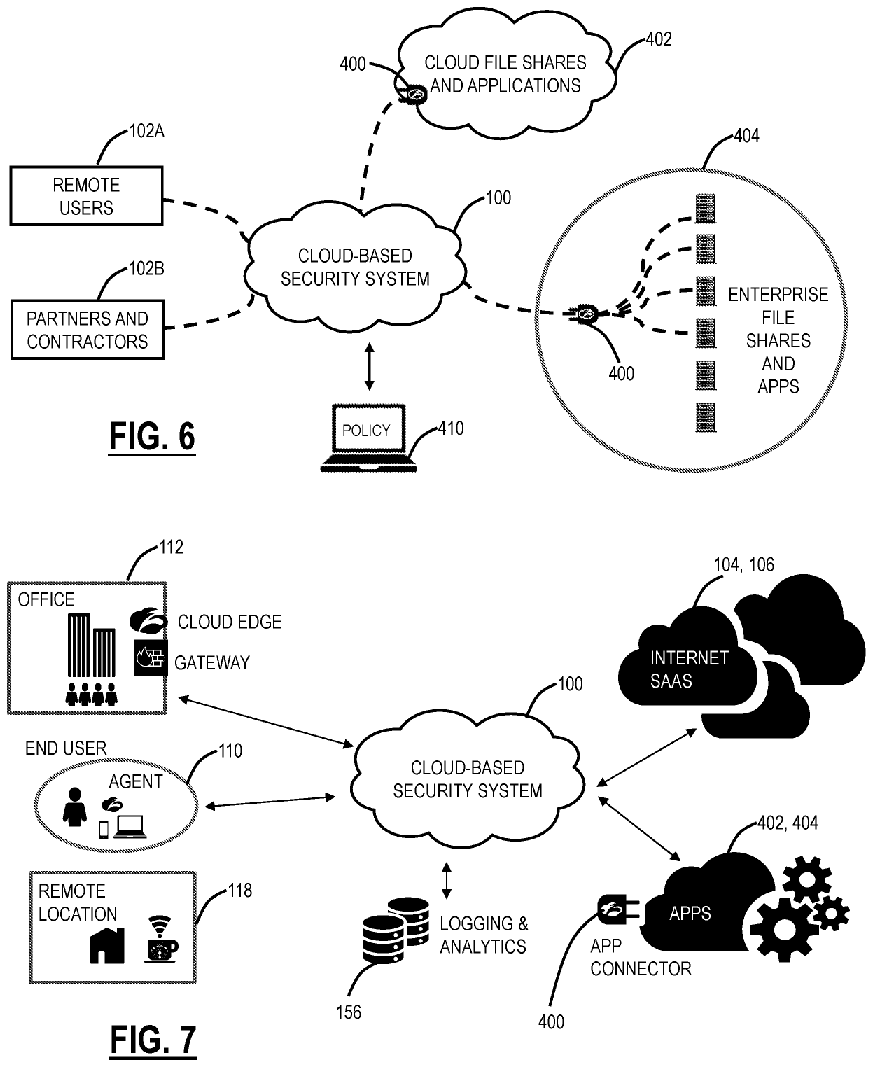

FIG. 6 is a network diagram of a Zero Trust Network Access (ZTNA) application utilizing the cloud-based system 100. For ZTNA, the cloud-based system 100 can dynamically create a connection through a secure tunnel between an endpoint (e.g., users 102A, 102B) that are remote and an on-premises connector 400 that is either located in cloud file shares and applications 402 and/or in an enterprise network 404, connected to enterprise file shares and applications. The connection between the cloud-based system 100 and on-premises connector 400 is dynamic, on-demand, and orchestrated by the cloud-based system 100. A key feature is its security at the edge—there is no need to punch any holes in the existing on-premises firewall. The connector 400 inside the enterprise (on-premises) “dials out” and connects to the cloud-based system 100 as if too were an endpoint. This on-demand dial-out capability and tunneling authenticated traffic back to the enterprise is a key differentiator for ZTNA. Also, this functionality can be implemented in part by the application 350 on the user device 300.

The paradigm of virtual private access systems and methods is to give users network access to get to an application and/or file share, not to the entire network. If a user is not authorized to get the application, the user should not be able even to see that it exists, much less access it. The virtual private access systems and methods provide an approach to deliver secure access by decoupling applications 402, 404 from the network, instead of providing access with a connector 400, in front of the applications 402, 404, an application on the user device 300, a central authority node 152 to push policy 410, and the cloud-based system 100 to stitch the applications 402, 404 and the software connectors 402, 404 together, on a per-user, per-application basis.

With the virtual private access, users can only see the specific applications 402, 404 allowed by the policy 410. Everything else is “invisible” or “dark” to them. Because the virtual private access separates the application from the network, the physical location of the application 402, 404 becomes irrelevant—if applications 402, 404 are located in more than one place, the user is automatically directed to the instance that will give them the best performance. The virtual private access also dramatically reduces configuration complexity, such as policies/firewalls in the data centers. Enterprises can, for example, move applications to Amazon Web Services or Microsoft Azure, and take advantage of the elasticity of the cloud, making private, internal applications behave just like the marketing leading enterprise applications. Advantageously, there is no hardware to buy or deploy, because the virtual private access is a service offering to end-users and enterprises. FIG. 5 can include the ZPA service from Zscaler, Inc.

### Digital Experience Monitoring

FIG. 7 is a network diagram of the cloud-based system 100 in an application of digital experience monitoring. Here, the cloud-based system 100 providing security as a service as well as ZTNA, can also be used to provide real-time, continuous digital experience monitoring, as opposed to conventional approaches (synthetic probes). A key aspect of the architecture of the cloud-based system 100 is the inline monitoring. This means data is accessible in real-time for individual users from end-to-end. As described herein, digital experience monitoring can include monitoring, analyzing, and improving the digital user experience.

The cloud-based system 100 connects users 102 at the locations 110, 112, 118 to the applications 402, 404, the Internet 104, the cloud services 106, etc. The inline, end-to-end visibility of all users enables digital experience monitoring. The cloud-based system 100 can monitor, diagnose, generate alerts, and perform remedial actions with respect to network endpoints, network components, network links, etc. The network endpoints can include servers, virtual machines, containers, storage systems, or anything with an IP address, including the Internet of Things (IoT), cloud, and wireless endpoints. With these components, these network endpoints can be monitored directly in combination with a network perspective. Thus, the cloud-based system 100 provides a unique architecture that can enable digital experience monitoring, network application monitoring, infrastructure component interactions, etc. Of note, these various monitoring aspects require no additional components—the cloud-based system 100 leverages the existing infrastructure to provide this service.

Again, digital experience monitoring includes the capture of data about how end-to-end application availability, latency, and quality appear to the end user from a network perspective. This is limited to the network traffic visibility and not within components, such as what application performance monitoring can accomplish. Networked application monitoring provides the speed and overall quality of networked application delivery to the user in support of key business activities. Infrastructure component interactions include a focus on infrastructure components as they interact via the network, as well as the network delivery of services or applications. This includes the ability to provide network path analytics.

The cloud-based system 100 can enable real-time performance and behaviors for troubleshooting in the current state of the environment, historical performance and behaviors to understand what occurred or what is trending over time, predictive behaviors by leveraging analytics technologies to distill and create actionable items from the large dataset collected across the various data sources, and the like. The cloud-based system 100 includes the ability to directly ingest any of the following data sources network device-generated health data, network device-generated traffic data, including flow-based data sources inclusive of NetFlow and IPFIX, raw network packet analysis to identify application types and performance characteristics, HTTP request metrics, etc. The cloud-based system 100 can operate at 10 gigabits (10G) Ethernet and higher at full line rate and support a rate of 100,000 or more flows per second or higher.

The applications 402, 404 can include enterprise applications, Office 365, Salesforce, Skype, Google apps, internal applications, etc. These are critical business applications where user experience is important. The objective here is to collect various data points so that user experience can be quantified for a particular user, at a particular time, for purposes of analyzing the experience as well as improving the experience. In an embodiment, the monitored data can be from different categories, including application-related, network-related, device-related (also can be referred to as endpoint-related), protocol-related, etc. Data can be collected at the application 350 or the cloud edge to quantify user experience for specific applications, i.e., the application-related and device-related data. The cloud-based system 100 can further collect the network-related and the protocol-related data (e.g., Domain Name System (DNS) response time).

### Application-Related Data

| | |
|---|---|
| Page Load Time | Redirect count (#) |
| Page Response Time | Throughput (bps) |
| Document Object Model (DOM) | Total size (bytes) |
| Load Time | |
| Total Downloaded bytes | Page error count (#) |
| App availability (%) | Page element count by category (#) |

### Network-Related Data

| | |
|---|---|
| HTTP Request metrics | Bandwidth |
| Server response time | Jitter |
| Ping packet loss (%) | Trace Route |
| Ping round trip | DNS lookup trace |
| Packet loss (%) | GRE/IPSec tunnel monitoring |
| Latency | MTU and bandwidth measurements |

### Device-Related Data (Endpoint-Related Data)

| | |
|---|---|
| System details | Network (config) |
| Central Processing Unit (CPU) | Disk |
| Memory (RAM) | Processes |
| Network (interfaces) | Applications |

Metrics could be combined. For example, device health can be based on a combination of CPU, memory, etc. Network health could be a combination of Wi-Fi/LAN connection health, latency, etc. Application health could be a combination of response time, page loads, etc. The cloud-based system 100 can generate service health as a combination of CPU, memory, and the load time of the service while processing a user's request. The network health could be based on the number of network path(s), latency, packet loss, etc.

The lightweight connector 400 can also generate similar metrics for the applications 402, 404. In an embodiment, the metrics can be collected while a user is accessing specific applications that user experience is desired for monitoring. In another embodiment, the metrics can be enriched by triggering synthetic measurements in the context of an inline transaction by the application 350 or cloud edge. The metrics can be tagged with metadata (user, time, app, etc.) and sent to a logging and analytics service for aggregation, analysis, and reporting. Further, network administrators can get UEX reports from the cloud-based system 100. Due to the inline nature and the fact the cloud-based system 100 is an overlay (in-between users and services/applications), the cloud-based system 100 enables the ability to capture user experience metric data continuously and to log such data historically. As such, a network administrator can have a long-term detailed view of the network and associated user experience.

### Cloud Tunnel

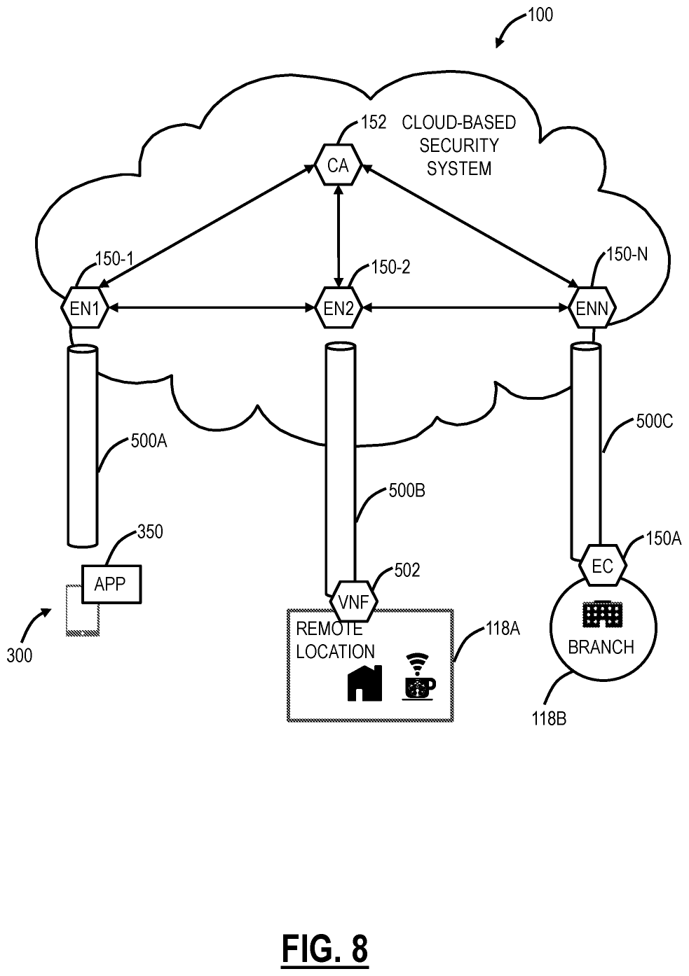

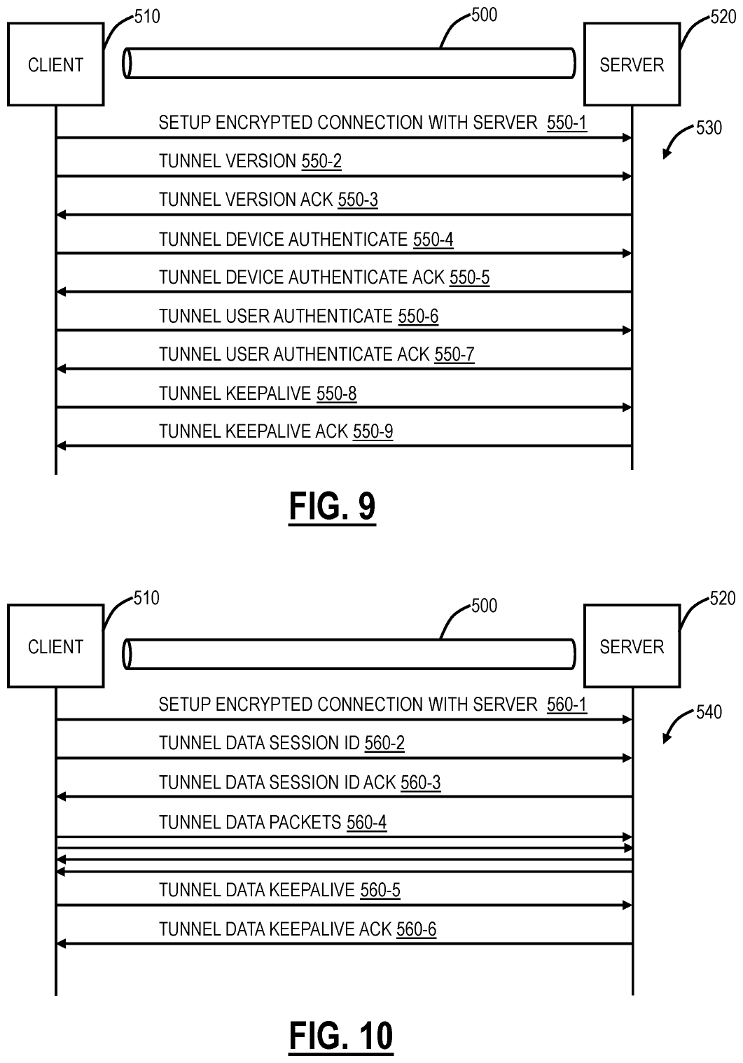

FIG. 8 is a network diagram of the cloud-based system 100 with various cloud tunnels 500, labeled as cloud tunnels 500A, 500B, 500C, for forwarding traffic. FIGS. 9 and 10 are flow diagrams of a cloud tunnel 500 illustrating a control channel (FIG. 9) and a data channel (FIG. 10), with the tunnel illustrated between a client 510 and a server 520. The cloud tunnel 500 is a lightweight tunnel that is configured to forward traffic between the client 510 and the server 520. The present disclosure focuses on the specific mechanisms used in the cloud tunnel 500 between two points, namely the client 510 and the server 520. Those skilled in the art will recognize the cloud tunnel 500 can be used with the cloud-based system 100 as an example use case, and other uses are contemplated. That is, the client 510 and the server 520 are just endpoint devices that support the exchange of data traffic and control traffic for the tunnel 500. For description, the server 520 can be referred to as a local node and the client 510 as a remote node, where the tunnel operates between the local and remote nodes.

In an embodiment, the cloud-based system 100 can use the cloud tunnel 500 to forward traffic to the enforcement nodes 150, such as from a user device 300 with the application 350, from a branch office/remote location 118, etc. FIG. 8 illustrates three example use cases for the cloud tunnel 500 with the cloud-based system 100, and other uses are also contemplated. In a first use case, a cloud tunnel 500A is formed between a user device 300, such as with the application 350, and an enforcement node 150-1. For example, when a user 102 associated with the user device 300 connects to a network, the application 350 can establish the cloud tunnel 500A to the closest or best enforcement node 150-1, and forward the traffic through the cloud tunnel 500A so that the enforcement node 150-1 can apply the appropriate security and access policies. Here, the cloud tunnel 500A supports a single user 102, associated with the user device 300.

In a second use case, a cloud tunnel 500B is formed between a Virtual Network Function (VNF) 502 or some other device at a remote location 118A and an enforcement node 150-2. Here, the VNF 502 is used to forward traffic from any user 102 at the remote location 118A to the enforcement node 150-2. In a third use case, a cloud tunnel 110C is formed between an on-premises enforcement node, referred to as an Edge Connector (EC) 150A, and an enforcement node 150-N. The edge connector 150A can be located at a branch office 118A or the like. In some embodiments, the edge connector 150A can be an enforcement node 150 in the cloud-based system 100 but located on-premises with a tenant. Here, in the second and third use cases, the cloud tunnels 500B, 500C support multiple users 102.

There can be two versions of the cloud tunnel 500, referred to a tunnel 1 and tunnel 2. The tunnel 1 can only support Web protocols as an HTTP connect tunnel operating on a TCP streams. That is, the tunnel 1 can send all proxy-aware traffic or port 80/443 traffic to the enforcement node 150, depending on the forwarding profile configuration. This can be performed via CONNECT requests, similar to a traditional proxy.

The tunnel 2 can support multiple ports and protocols, extending beyond only web protocols. As described herein, the cloud tunnels 500 are the tunnel 2. In all of the use cases, the cloud tunnel 500 enables each user device 300 to redirect traffic destined to all ports and protocols to a corresponding enforcement node 150. Note, the cloud-based system 100 can include load balancing functionality to spread the cloud tunnels 500 from a single source IP address. The cloud tunnel 500 supports device logging for all traffic, firewall, etc., such as in the storage cluster 156. The cloud tunnel 500 utilizes encryption, such as via TLS or DTLS, to tunnel packets between the two points, namely the client 510 and the server 520. As described herein, the client 510 can be the user device 300, the VNF 1102, and/or the edge connector 150A, and the server 520 can be the enforcement node 150. Again, other devices are contemplated with the cloud tunnel 500.

The cloud tunnel 500 can use a Network Address Translation (NAT) device that does not require a different egress IP for each device's 300 separate sessions. Again, the cloud tunnel 500 has a tunneling architecture that uses DTLS or TLS to send packets to the cloud-based system 100. Because of this, the cloud tunnel 500 is capable of sending traffic from all ports and protocols.

Thus, the cloud tunnel 500 provides complete protection for a single user 102, via the application 350, as well as for multiple users at remote locations 118, including multiple security functions such as cloud firewall, cloud IPS, etc. The cloud tunnel 500 includes user-level granularity of the traffic, enabling different users 102 on the same cloud tunnel 500 for the enforcement nodes 150 to provide user-based granular policy and visibility. In addition to user-level granularity, the cloud tunnel 500 can provide application-level granularity, such as by mapping mobile applications (e.g., Facebook, Gmail, etc.) to traffic, allowing for app-based granular policies.

FIGS. 9 and 10 illustrate the two communication channels, namely a control channel 530 and a data channel 540, between the client 510 and the server 520. Together, these two communication channels 530, 540 form the cloud tunnel 500. In an embodiment, the control channel 530 can be an encrypted TLS connection or SSL connection, and the control channel 530 is used for device and/or user authentication and other control messages. In an embodiment, the data channel 540 can be an encrypted DTLS or TLS connection, i.e., the data channel can be one or more DTLS or TLS connections for the transmit and receive of user IP packets. There can be multiple data channels 540 associated with the same control channel 530. The data channel 540 can be authenticated using a Session Identifier (ID) from the control channel 530.

Of note, the control channel 530 always uses TLS because some locations (e.g., the remote location 118A, the branch office 118B, other enterprises, hotspots, etc.) can block UDP port 443, preventing DTLS. Whereas TLS is widely used and not typically blocked. The data channel 540 preferably uses DTLS, if it is available, i.e., not blocked on the client 530. If it is blocked, the data channel 540 can use TLS instead. For example, DTLS is the primary protocol for the data channel 540 with TLS used as a fallback over TCP port 443 if DTLS is unavailable, namely if UDP port 443 is blocked at the client 530.

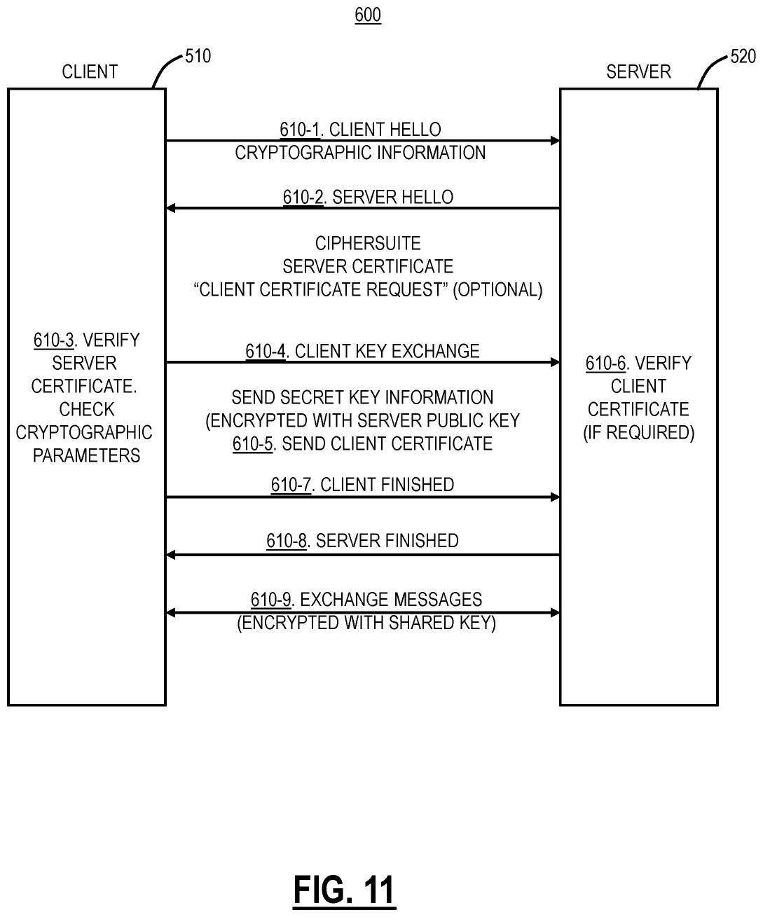

In FIG. 9, the control channel 530 is illustrated with exchanges between the client 510 and the server 520. Again, the control channel 530 includes TLS encryption, which is established through a setup or handshake between the client 510 and the server 520 (step 550-1). An example of a handshake is illustrated in FIG. 11. The client 510 can send its version of the tunnel 500 to the server 520 (step 550-2) to which the server 520 can acknowledge (step 550-3). For example, the version of the tunnel can include a simple version number or other indication, as well as an indication of whether the client 510 supports DTLS for the data channel 540. Again, the control channel 530 is fixed with TLS or SSL, but the data channel 540 can be either DTLS or TLS.

The client 510 can perform device authentication (step 550-4), and the server 520 can acknowledge the device authentication (step 550-5). The client 510 can perform user authentication (step 550-6), and the server 520 can acknowledge the user authentication (step 550-7). Note, the device authentication includes authenticating the user device 300, such as via the application 350, the VNF 502, the edge connector 150A, etc. The user authentication includes authenticating the users 102 associated with the user devices 300. Note, in an embodiment, the client 510 is the sole device 300, and here the user authentication can be for the user 102 associated with the client 510, and the device authentication can be for the user device 300 with the application 350. In another embodiment, the client 510 can have multiple user devices 300 and corresponding users 102 associated with it. Here, the device authentication can be for the VNF 502, the edge connector 150A, etc., and the user authentication can be for each user device 300 and corresponding user 102, and the client 510 and the server 520 can have a unique identifier for each user device 300, for user-level identification.

The device authentication acknowledgment can include a session identifier (ID) that is used to bind the control channel 530 with one or more data channels 540. The user authentication can be based on a user identifier (ID) that is unique to each user 102. The client 510 can periodically provide keep alive packets (step 550-8), and the server 510 can respond with keep alive acknowledgment packets (step 550-9). The client 510 and the server 520 can use the keep alive packets or messages to maintain the control channel 530. Also, the client 510 and the server 520 can exchange other relevant data over the control channel 530, such as metadata, which identifies an application for a user 102, location information for a user device 300, etc.

In FIG. 10, similar to FIG. 9, the data channel 540 is illustrated with exchanges between the client 510 and the server 520. Again, the data channel 540 includes TLS or DTLS encryption, which is established through a setup or handshake between the client 510 and the server 520 (step 560-1). An example of a handshake is illustrated in FIG. 11. Note, the determination of whether to use TLS or DTLS is based on the session ID, which is part of the device authentication acknowledgment, and which is provided over the data channel 540 (steps 560-2, 560-3). Here, the client 510 has told the server 520 its capabilities, and the session ID reflects what the server 520 has chosen, namely TLS or DTLS, based on the client's 510 capabilities. In an embodiment, the server 520 chooses DTLS if the client 510 supports it, i.e., if UDP port 443 is not blocked, otherwise the server 520 chooses TLS. Accordingly, the control channel 530 is established before the data channel 540. The data channel 540 can be authenticated based on the session ID from the control channel 530.

The data channel 540 includes the exchange of data packets between the client 510 and the server 520 (step 560-4). The data packets include an identifier such as the session ID and a user ID for the associated user 102. Additionally, the data channel 540 can include keep alive packets between the client 510 and the server 520 (steps 560-5, 560-6).

The cloud tunnel 500 can support load balancing functionality between the client 510 and the server 520. The server 520 can be in a cluster, i.e., multiple servers 200. For example, the server 520 can be an enforcement node 150 cluster in the cloud-based system 100. Because there can be multiple data channels 540 for a single control channel 530, it is possible to have the multiple data channels 540, in a single cloud tunnel 500, connected to different physical servers 200 in a cluster. Thus, the cloud-based system 100 can include load balancing functionality to spread the cloud tunnels 500 from a single source IP address, i.e., the client 510.

Also, the use of DTLS for the data channels 540 allows the user devices 300 to switch networks without potentially impacting the traffic going through the tunnel 500. For example, a large file download could continue uninterrupted when a user device 300 moves from Wi-Fi to mobile, etc. Here, the application 350 can add some proprietary data to the DTLS client-hello servername extension. That proprietary data helps a load balancer balance the new DTLS connection to the same server 200 in a cluster where the connection prior to network change was being processed. So, a newly established DTLS connection with different IP address (due to network change) can be used to tunnel packets of the large file download that was started before the network change. Also, some mobile carriers use different IP addresses for TCP/TLS (control channel) and UDP/DTLS (data channel) flows. The data in DTLS client-hello helps the load balancer balance the control and data connection to the same server 200 in the cluster.

### User and Application-Level Awareness

The tunnel 500 is aware of every user based on the user ID, which is associated with data packets on the data channel 540. This allows the cloud-based system 100 to apply per user-level functions on data traffic where there are multiple users 102 on the tunnel 500. In another embodiment, a user 102 can be operating a mobile device for the user device 300. Many mobile apps are not differentiated in transit. Here, in an embodiment, the application 350 can have the ability to dump operating system network connection tables, derive application or process (names) associated with established connections (TCP/UDP), and tag ab application ID on every packet over the data channel 540. In such a manner, the tunnel 500 can support both per user and per application-level awareness.

### Encryption Handshake Process

FIG. 11 is a flow diagram of details of a handshake process 600 between the client 510 and the server 520. Again, the client 510 and the server 520 are labeled as such but could be any two endpoints of a cloud tunnel 500. The client 510 sends a “client hello” message that lists cryptographic information such as the SSL/TLS/DTLS version and, in the client's order of preference, the CipherSuites supported by the client 510 (step 610-1). The message also contains a random byte string that is used in subsequent computations. The protocol allows for the “client hello” to include the data compression methods supported by the client 510.

The server 520 responds with a “server hello” message that contains the CipherSuite chosen by the server 520 from the list provided by the client 510, the session ID, and another random byte string (step 610-2). The server 520 also sends its digital certificate. If the server 520 requires a digital certificate for client authentication, the server 520 sends a “client certificate request” that includes a list of the types of certificates supported and the Distinguished Names of acceptable CAs. The client 510 verifies the server's 520 digital certificates (step 610-3).

The client 510 sends the random byte string that enables both the client 510 and the server 520 to compute the secret key to be used for encrypting subsequent message data (step 510-4). The random byte string itself is encrypted with the server's 520 public key. In an embodiment, for the data channel 540, the random byte string can be the session ID, which of course, is not random. If the server 520 sent a “client certificate request,” the client 510 sends a random byte string encrypted with the client's private key, together with the client's 510 digital certificates, or a “no digital certificate alert” (step 610-5). This alert is only a warning, but with some implementations, the handshake fails if client authentication is mandatory. The server 520 verifies the client's certificate if required (step 610-6).

The client 510 sends the server a “finished” message, which is encrypted with the secret key, indicating that the client 510 part of the handshake is complete (step 610-7). The server 520 sends the client 510 a “finished” message, which is encrypted with the secret key, indicating that the server 520 part of the handshake is complete. For the duration of the session, the server 520 and client 510 can now exchange messages that are symmetrically encrypted with the shared secret key (step 610-9).

### Cloud Tunnel Bypass

Again, the present cloud-based tunnel protocol systems and methods for multiple ports and protocols include the utilization of various control and data channels. The tunneling architecture utilizes DTLS and/or TLS to send packets to servers 520 associated with the cloud-based system 100, i.e., nodes 150. Because of this, the present tunneling processes can send all ports and protocols. The tunnel 500 can establish an encrypted TLS control channel to a closest, or specified, node 150 for user authentication and device fingerprinting. Thereafter, data is sent through one or more null-encrypted DTLS or TLS data channels. The control channel is used for device and/or end-user authentication, which establishes a session-id for the subsequent data tunnels in addition to allowing the detection of what transfer modes are supported by the node 150. In various embodiments, the control channel is always TLS based and is responsible for acquiring the session-id for a data channel to use.

In various embodiments, the tunnels described herein (tunnel 1 and tunnel 2) can include tunnel support bypass features. That is, various mechanisms can be utilized to bypass specific functions of the tunnels 500. This can provide the ability to bypass specific domains/FQDNS without configuring a forwarding profile Proxy Auto-Configuration (PAC). In the present disclosure, a forwarding profile PAC is utilized to define how traffic from the system, browser, and applications of a device is directed to the application 350 on the device. Before such features, bypass domains were required to be defined in the forwarding and app profile PAC. In the present disclosure, an app profile PAC is utilized to define how traffic is directed from the application 350 to the cloud-based system 100. In various embodiments, the app profile PAC includes domains, VPN hostnames, and various actions to be performed for the listed domains and VPN hostnames. These actions can include sending traffic directly (bypass), send traffic via the processes of tunnel 1 or tunnel 2, send traffic to a specific node 150, etc.

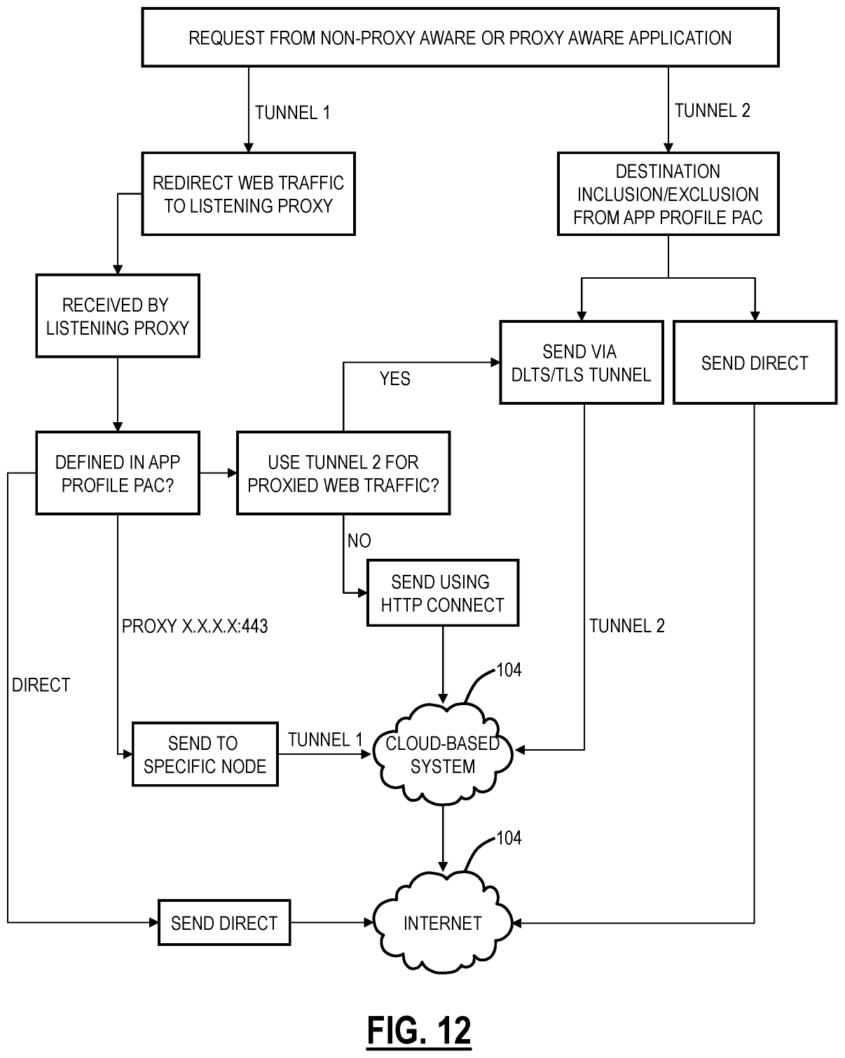

FIG. 12 is a flow diagram of a process for performing domain-based bypassing within cloud tunnels. Typically, domain based bypass requires a forwarding profile PAC, which downgrades any browser traffic to tunnel 1, so it can be parsed through the app profile PAC for bypasses. In an embodiment depicted in FIG. 12, the app profile PAC can be utilized for bypassing without the need for the forwarding profile PAC. That is, all web traffic is forwarded to a listening proxy of the application 350 or Edge Connector (EC) 150A, and from there, the app profile PAC is used to facilitate the bypassing. This enables the application 350 or Edge Connector 150A to parse all 80/443 traffic which is received on the listening proxy. It will also consider the app profile PAC before tunneling the traffic which means that the application 350 or Edge Connector 150A will honor the domains being sent direct or the multi-connect feature to send specified traffic to another proxy/node. For example, statements within the app profile PAC defining one or more domains to be sent directly will ensure that domains specified will be sent directly to the internet, and also sent to a node in a different data center if explicitly stated within the app profile PAC.

The present example shown contemplated communication between a device having the application 350 executing thereon and the various nodes 150 of the cloud-based system 100. The steps shown in FIG. 12 include, when utilizing tunnel 1, responsive to receiving web traffic at the application 350, referencing the app profile PAC. Depending on if there is an action defined in the app profile PAC, the systems can send the traffic direct to the internet 104, send the traffic to the cloud-based system 100 as described herein, or, based on a flag being enabled or disabled, send the traffic to the cloud-based system 100 using the steps described for tunnel 2. Alternatively, when initially utilizing tunnel 2, the application 350 can determine, via the app profile PAC, if the destination associated with the traffic is defined as being included or excluded, i.e., should it bypass the cloud-based system or not. If it is excluded, the traffic is sent directly to the internet, bypassing the cloud-based system 100. If it is defined as included, the traffic is sent via the processes described for tunnel 2 defined herein.

In another example, when initially utilizing tunnel 1, and when the flag specifies to use tunnel 2 for proxied web traffic, upon receiving any proxied web traffic at the application 350, the systems can automatically forward it utilizing the processes described for tunnel 2. By having the ability to transition from utilizing tunnel 1 to utilizing tunnel 2, they systems can implement load balancing as described herein and encryption of the traffic rather than forwarding the traffic in plain text.

### TLS Data Over Control Channel

Again, when referring to tunnel 2, the control channel 530 always uses TLS because some locations (e.g., the remote location 118A, the branch office 118B, other enterprises, hotspots, etc.) can block UDP port 443, preventing DTLS. Whereas TLS is widely used and not typically blocked. The data channel 540 preferably uses DTLS, if it is available, i.e., not blocked on the client 530. If it is blocked, the data channel 540 can use TLS instead. For example, DTLS is the primary protocol for the data channel 540 with TLS used as a fallback over TCP port 443 if DTLS is unavailable, namely if UDP port 443 is blocked at the client 530.

In various embodiments, if DTLS is not an available protocol, the systems can utilize the control channel to send data. That is, a single channel for control and data communication is contemplated with no separate TLS data channel. If the tunnel protocol is DTLS, only then will a separate data channel be established.

### Server Handoff

In some cases, a loss of connection can be experienced due to a handoff between servers. This can occur when a secondary server 520 is being utilized while the systems try to connect to a primary server 520. Previously, if a client 510 had an established connection to a secondary server 520 via tunnel 2, this connection was broken when trying to connect to a primary server 520. This is because only a single tunnel 2 instance was allowed, and a new tunnel 2 connection was needed to move back to a primary server 520.

To alleviate such deficiencies, the present disclosure provides a soft handoff feature for transitioning between servers 520. That is, the application 350 or Edge Connector (EC) 150A can support multiple tunnel 2 instances. A new tunnel connection can be tried without breaking the existing connection. More particularly, multiple tunnel managers can be executed, wherein one is passive and another is active. In an embodiment, when a secondary server 520 is being used for a connection, the passive tunnel manager can be utilized to check if a tunnel connection can be established to a primary server 520 without breaking the connection established by the active tunnel manager.

### Cloud Tunnel Process

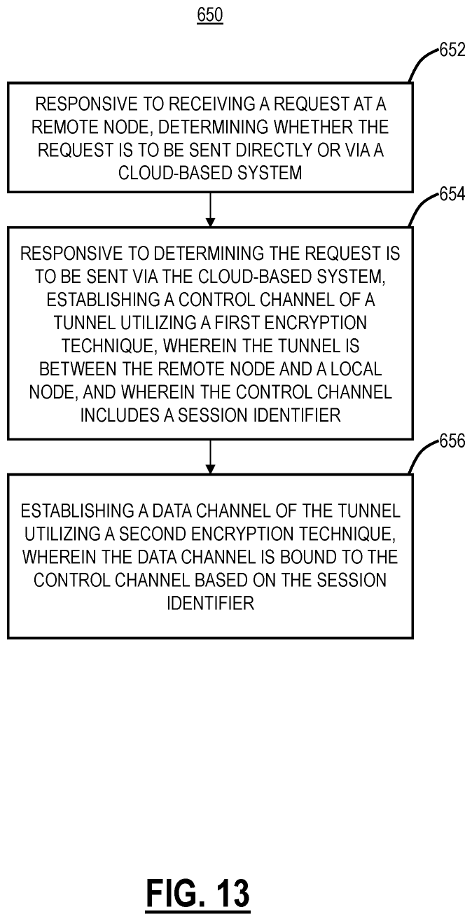

FIG. 13 is a process 650 for establishing a cloud tunnel for forwarding traffic between a remote node and a local node. The process 650 includes responsive to receiving a request at a remote node, determining whether the request is to be sent directly or via a cloud-based system (step 652); responsive to determining the request is to be sent via the cloud-based system, establishing a control channel of a tunnel utilizing a first encryption technique, wherein the tunnel is between the remote node and a local node, and wherein the control channel includes a session identifier (step 654); and establishing a data channel of the tunnel utilizing a second encryption technique, wherein the data channel is bound to the control channel based on the session identifier (step 656).

The process 650 can further include wherein the determining is based on any of a domain and a hostname of a destination associated with the request. The steps can further include responsive to determining the request is to be sent directly, forwarding the request direct to the Internet. The first encryption technique can be one of Transport Layer Security (TLS) and Secure Sockets Layer (SSL), and the second encryption technique can be one of TLS and Datagram Transport Layer Security (DTLS). The first encryption technique can be a same one of TLS and SSL, and the second encryption technique can be selected as the one of TLS and DTLS based on support of the remote node. The steps can further include performing, over the control channel, device authentication and user authentication of one or more users associated with the remote node, wherein each of the one or more users includes a user identifier; and subsequent to the device authentication and the user authentication, exchanging data packets over the data channel with each data packet including a corresponding user identifier. The data packets can include data packets between the remote node and the local node from various ports and having different protocols. The data packets can be exchanged over the control channel. The first encryption technique and the second encryption technique can be different. The local node can be part of a cloud-based security system and the one or more users can be connected thereto via the tunnel for firewall and Intrusion Prevention System (IPS) functions.

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device such as hardware, software, firmware, and a combination thereof can be referred to as “circuitry configured or adapted to,” “logic configured or adapted to,” etc. perform a set of operations, steps, methods, processes, algorithms, functions, techniques, etc. as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read-Only Memory), an EPROM (Erasable Programmable Read-Only Memory), an EEPROM (Electrically Erasable Programmable Read-Only Memory), Flash memory, and the like. When stored in the non-transitory computer-readable medium, the software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A non-transitory computer-readable medium storing computer-executable instructions, and in response to execution by one or more processors, the computer-executable instructions cause the one or more processors to perform steps of:
responsive to receiving a request at a remote node, determining whether the request is to be sent directly or via a cloud-based system;
responsive to determining the request is to be sent via the cloud-based system, establishing a control channel of a tunnel utilizing a first encryption technique, wherein the tunnel is between the remote node and a local node, and wherein the control channel includes a session identifier; and
establishing a data channel of the tunnel utilizing a second encryption technique, wherein the data channel is bound to the control channel based on the session identifier.

2. The non-transitory computer-readable medium of claim 1, wherein the determining is based on any of a domain and a hostname of a destination associated with the request.

3. The non-transitory computer-readable medium of claim 1, wherein the instructions further cause the one or more processors to perform the steps of:
responsive to determining the request is to be sent directly, forwarding the request direct to the Internet.

4. The non-transitory computer-readable medium of claim 1, wherein the first encryption technique is one of Transport Layer Security (TLS) and Secure Sockets Layer (SSL), and the second encryption technique is one of TLS and Datagram Transport Layer Security (DTLS).

5. The non-transitory computer-readable medium of claim 4, wherein the first encryption technique is always a same one of TLS and SSL, and the second encryption technique is selected as the one of TLS and DTLS based on support of the remote node.

6. The non-transitory computer-readable medium of claim 1, wherein the instructions further cause the one or more processors to perform the steps of:
performing, over the control channel, device authentication and user authentication of one or more users associated with the remote node, wherein each of the one or more users includes a user identifier; and
subsequent to the device authentication and the user authentication, exchanging data packets over the data channel with each data packet including a corresponding user identifier.

7. The non-transitory computer-readable medium of claim 6, wherein the data packets include data packets between the remote node and the local node from various ports and having different protocols.

8. The non-transitory computer-readable medium of claim 6, wherein the data packets are exchanged over the control channel.

9. The non-transitory computer-readable medium of claim 1, wherein the first encryption technique and the second encryption technique are different.

10. The non-transitory computer-readable medium of claim 1, wherein the local node is part of a cloud-based security system wherein one or more users are connected thereto via the tunnel for firewall and Intrusion Prevention System (IPS) functions.

11. A method comprising steps of:
responsive to receiving a request at a remote node, determining whether the request is to be sent directly or via a cloud-based system;
responsive to determining the request is to be sent via the cloud-based system, establishing a control channel of a tunnel utilizing a first encryption technique, wherein the tunnel is between the remote node and a local node, and wherein the control channel includes a session identifier; and
establishing a data channel of the tunnel utilizing a second encryption technique, wherein the data channel is bound to the control channel based on the session identifier.

12. The method of claim 11, wherein the determining is based on any of a domain and a hostname of a destination associated with the request.

13. The method of claim 11, wherein the steps further comprise:
responsive to determining the request is to be sent directly, forwarding the request direct to the Internet.

14. The method of claim 11, wherein the first encryption technique is one of Transport Layer Security (TLS) and Secure Sockets Layer (SSL), and the second encryption technique is one of TLS and Datagram Transport Layer Security (DTLS).

15. The method of claim 14, wherein the first encryption technique is always a same one of TLS and SSL, and the second encryption technique is selected as the one of TLS and DTLS based on support of the remote node.

16. The method of claim 11, wherein the steps further comprise:
performing, over the control channel, device authentication and user authentication of one or more users associated with the remote node, wherein each of the one or more users includes a user identifier; and
subsequent to the device authentication and the user authentication, exchanging data packets over the data channel with each data packet including a corresponding user identifier.

17. The method of claim 16, wherein the data packets include data packets between the remote node and the local node from various ports and having different protocols.

18. The method of claim 16, wherein the data packets are exchanged over the control channel.

19. The method of claim 11, wherein the first encryption technique and the second encryption technique are different.

20. The method of claim 11, wherein the local node is part of a cloud-based security system wherein one or more users are connected thereto via the tunnel for firewall and Intrusion Prevention System (IPS) functions.
